(19) United States
(12) Patent Application Publication
(10) Pub. No.: US 2009/0245206 A1
(43) Pub. Date: Oct. 1, 2009

(54) METHOD FOR SEARCHING FOR RADIO NETWORK, AND SYSTEM, AND MULTIMODE DEVICE

(75) Inventor: Yongjun Liu, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/484,782

(22) Filed: Jun. 15, 2009

Related U.S. Application Data
(63) Continuation of application No. PCT/CN2007/071242, filed on Dec. 14, 2007.

(30) Foreign Application Priority Data
Dec. 15, 2006 (CN) 200610147355.9

(51) Int. Cl. H04W 36/00; H04W 84/02

(52) U.S. Cl. 370/331; 370/338

(57) ABSTRACT

A method for searching for a radio network, and system, and a multimode device, which shortens the delay of handing over the multimode device between networks and reduces the power consumption of the multimode device in searching for the network. In the embodiments of the present invention, the multimode device uses the second network as an area reference. A correlation is preset between each area in the second network and the radio network parameters of the first network in the area. Therefore, the multimode device searches the first network according to the radio network parameters of the first network correlated with the current area in the second network when it moves. The correlation information may be stored in the management device of the first network, or the management device of the second network, or stored in the multimode device directly.

### CROSS-REFERENCE TO RELATED APPLICATIONS

This application is a continuation of International Application No. PCT/CN2007/071242, filed Dec. 14, 2007, which claims the priority of CN application No. 200610147355.9 filed on Dec. 15, 2006, the entire contents of all of which are incorporated herein by reference.

### FIELD OF THE INVENTION

The present invention relates to mobile communication, and in particular, to a technology of searching for a radio network by a multimode device.

### BACKGROUND

Mobility influences the quality of the communication in all the mobile communication networks, such as Global System for Mobile Communication (GSM) networks and Wideband Code Division Multiple Access (WCDMA) networks. In the existing wireless communication networks, a mobile station needs to be connected to some access point, which has specific wireless coverage, to implement communication. Being carried by a moving user, the mobile station moves from the coverage of one access point to the coverage of another access point, and its handover from the former access point to the new access point within the serving network is performed usually according to the change of its location or the service balance requirement. Afterwards, the service is provided to mobile station by the new access point, which belongs to the same service network as the former access point.

The influence of mobility is much more significant in short-distance radio communication networks, where handover occurs more frequently because of the limited coverage of an access point. For example, the coverage of a Wi-Fi access point is about 100 m, the coverage of a ZigBee access point is about 80 m, and the coverage of Bluetooth is less than 10 m. The faster the mobile station moves, the quicker it leaves the coverage of a former access point and enters the coverage of a new access point. The communication will be interrupted if the mobile station fails to implement handover between the access points.

Handover is generally performed in two methods. The first method is to monitor the communication channel periodically. If the energy of the receiving signal is lower than a threshold, or if the signal-to-noise ratio is deteriorated, all possible working channels including the current channel are scanned, and a best new access point is selected according to the information from all network nodes. If the best new access point locates in another network, handover between networks is performed. The continuity of the communication is maintained, and the mobile station shifts to the new access point as soon as getting out of touch with the former access point. The second method is that the mobile station does not scan the network for a new access point until the communication fails. Due to a long delay and discontinuous communication, this method is suitable for the data services which require no continuous communication. However, this method avoids the need of detecting the channels periodically and saves energy. Therefore, some networks use such a passive processing technology to deal with mobility.

Based on the methods above, it is essential for a mobile station to scan the network, which causes delay and power consumption, to obtain enough information of the new access point to access the network again. The delay caused by the handover between the access points inside a network is not as long as the delay caused by the handover between networks. All the access points inside the network have the same network identifier, and usually use the same channel or channel sequence. Therefore, the mobile station has to scan the existing channel to perform handover between the access points with the same network identifier inside a network. However, different networks may use different working channels, and have different network identifiers or network keys. Therefore, to perform handover between networks, the mobile station may have to scan the access points on all the working channels, attempt the nodes with different network identifiers, and request the network key, which causes long delay and large consuming energy. Thus, it is essential to improve the mobility performance of the mobile station moving between networks, and shorten handover delay and power consumption.

It is worthy of attention that: Different networks mentioned above are called subnets of the overall serving network. The subnets may be multiple short-distance radio communication networks providing the same service in a great serving network, and the serving network comprises the limited coverage corresponding to the subnets. The subnets may be connected through bridges or gateways; they may be geographically continuous and provide a service like traditional cellular networks. The subnets may be geographically discontinuous, for example, a user may deploy a Wireless Personal Area Network (WPAN) at home and in the office, and the WPANs are connected to another large network such as Internet through gateways through gateways.

### SUMMARY

Various embodiments of the present invention provide a method and system for searching for radio network, which may shorten the delay caused by the handover between networks and reduce the power consumption of the multimode device in searching for the network, and a multimode device.

A method for a multimode device to search for a radio network is provided in an embodiment of the present invention. The method includes the following steps:

obtaining, by the multimode device, radio network parameters of a first network correlated with a current area according to identifier information of the current area and correlation information, wherein the correlation information presents a correlation between identifier information of an area in a second network and radio network parameters of the first network in the area; and

searching the first network according to the radio network parameters.

A telecommunication system is provided in an embodiment of the present invention. The system includes a first network corresponding to a mode, a second network corresponding to a different mode, and a multimode device supporting at least the two modes, and further includes:

a storage apparatus, configured to store information about correlation between the identifier information of an area in the second network and the radio network parameters of the first network in the area; and

a multimode device, configured to obtain radio network parameters of the first network correlated with the current area according to the identifier information of the current area and the stored correlation information, and search the first network according to the radio network parameters.

A multimode device provided in an embodiment of the present invention includes:

a correlation information obtaining unit, configured to obtain the radio network parameters of the first network correlated with a current area in the second network according to the identifier information of the area; and

a network searching unit, configured to search the first network according to the obtained radio network parameters.

Compared with the prior art, the embodiments of the present invention provide the following benefits:

Because the networks located in different areas correspond to different network parameters, the delay is long and more power is consumed if the multimedia device performs network search for all the possible network parameters every time when performing network handover. A correlation is preset between each area in the second network and the radio network parameters of the first network in the area by using the second network as an area reference. Therefore, the multimode device search the first network according to the radio network parameters of the first network correlated with the current area in the second network when it moves. Because the area in the second network is correlated with a limited number of parameters of the first network, the scope of network search is reduced, handover delay is shortened, and searching for unrelated parameters is avoided in the network, and power consumption of network search is reduced.

### BRIEF DESCRIPTION OF THE DRAWINGS

FIG. 1 shows a network layout of a method for a multimode device to search for a radio network in a first embodiment of the present invention;

FIG. 2 is a flowchart of a method for a multimode device to search for a radio network in the first embodiment of the present invention;

FIG. 3 shows a network layout of a method for a multimode device to search for a radio network in a third embodiment of the present invention;

FIG. 4 shows a network layout of a method for a multimode device to search for a radio network in a sixth embodiment of the present invention;

FIG. 5 shows a network layout of a method for a multimode device to search for a radio network in a seventh embodiment of the present invention;

FIG. 6 shows a network layout of a method for a multimode device to search for a radio network in a eighth embodiment of the present invention; and

FIG. 7 shows a system in the eighth embodiment of the present invention.

### DETAILED DESCRIPTION

In order to make the technical solution and merits of the present invention clearer, the present invention is hereinafter described in detail by reference to accompanying drawings and preferred embodiments.

In the embodiments of the present invention, the multimode device uses the second network as an area reference. A correlation is preset between each area in the second network and the radio network parameters of the first network in the area. Therefore, the multimode device search the first network according to the radio network parameters of the first network correlated with the current area in the second network when it moves. In the network search based on the correlated radio network parameters of the first network, the first network correlated in the corresponding area in the second network is searched instead of searching the first network in all areas. Therefore, the scope of network search is narrowed, the handover delay is shortened, and the power consumption of network search is reduced.

A mobile station that can access multiple networks of different modes simultaneously is called as a multimode device. For example, if a Bluetooth module is integrated in a GSM mobile station, the multimedia device may set up a Bluetooth network connection with other Bluetooth devices when the multimode device is connected to the GSM network. The technical solution under the embodiments of the present invention may shorten the time spent by the multimode device in searching for the network and the delay of handover between networks, and improve the mobility performance of the multimode device.

In the method for a multimode device to search for a radio network in the first embodiment of the present invention, the operator or service provider deploys some short-distance radio networks in hotspot areas to provide services for users. For example, flight information is provided at an airport, commodity sale information is provided in shops, and so on. Such a short-distance radio network is called “a first network”. The coverage of the short-distance radio network is overlapped with the coverage of the general cellular network. The multimode device, such as a mobile station supporting both cellular network access and Bluetooth technology, may use the cellular network services provided by the cellular network operator, and access the short-distance radio network. The user of a multimode device enjoys the services provided by the operator or service provider conveniently when the user accesses the short-distance radio network.

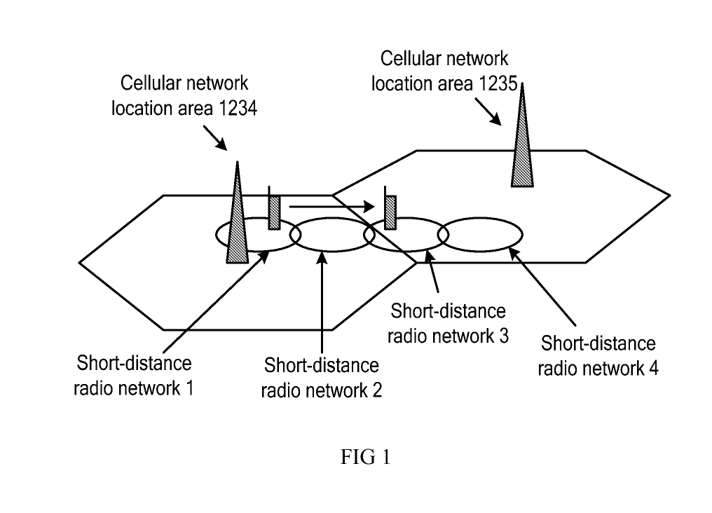

In this embodiment, the short-distance radio network is the first network, and the cellular network with large coverage, such as a GSM network, is the second network. As shown in FIG. 1, it is assumed that an operator sets short-distance radio networks 1 and 2 within the coverage of base station 1 in a cellular network, and sets short-distance radio networks 3 and 4 within the coverage of base station 2. Such short-distance radio networks use different working channels. For example, 16 working channels are available, and the short-distance radio networks 1-4 use channels 1, 6, 11, and 16 respectively.

In order to search a network quickly, configuration is performed before deploying the short-distance radio network. That is, to set up a correlation between the identifier information of each area in the cellular network and the network parameters of each short-distance radio network in the area. In this embodiment, the correlation is stored in the management device of the second network, namely, the cellular network. The correlation is set up through a configuration device in the short-distance radio network or cellular network. The configuration device is capable of accessing the cellular network and the short-distance radio network at the same time.

In an embodiment, the configuration device accesses one by one the short-distance radio networks that need to be correlated, and sends a correlation request command to the cellular network base station in the area where the short-distance radio network is located. The correlation request command carries the radio network parameters, such as a working channel code, of the currently correlated short-distance radio network. The correlation request command is sent to the management device of the cellular network through the base station. The management device checks whether the correlation between the location area identifier, namely, identifier uniquely corresponding to the area covered by each different base station, of the base station and the short-distance radio network exists currently. If the correlation does not exist, a correlation between the location area identifier of the base station and the working channel code of the current short-distance radio network is added. If the correlation exists, the working channel code of the current short-distance radio network is further correlated with the location area identifier of the base station in the existing correlation. Therefore, the correlation includes the working channels of all short-distance radio networks in the coverage of the base station, and the multimode device may attempt any possible network access according to the correlation.

A specific correlation in the network layout shown in FIG. 1 is described below through an example. The configuration device accesses the short-distance radio network 1, and obtains the information of the working channel used by the short-distance radio network 1 at the same time. The configuration device sends a correlation request command to the cellular network base station 1 in the current area. The correlation request command specifies the working channel of the short-distance radio network to be 1. If there are 16 working channels in total, the working channel may be represented by a 2-byte (16 bits) field. The bit corresponding to the channel which is used is set to “1” in the field, and the bit corresponding to the channel which is not used is set to “0”. For example, 0x0001 (hexadecimal) indicates that the short-distance radio network 1 uses channel 1. Further, base station 1 sends the correlation request command and the location area identifier “1234” of the area covered by the base station to the management device of the cellular network; if the management device is included in base station 1, no correlation request command needs to be forwarded. After receiving the correlation request command, the management device of the cellular network checks whether the service provider is entitled to use the location correlation service. If the service provider is entitled, the correlation to the location area identifier “1234” is added in the correlation information table. The channel code corresponding to the location area identifier “1234” is set to “0x0001”, and a correlation success response is returned to the configuration device through base station 1. Subsequently, the configuration device accesses the short-distance radio network 2, and sends a location correlation request command carrying 0x0020 as the working channel code, which indicates the short-distance radio network 2 uses the working channel 6. The request is sent by base station 1 to the management device of the cellular network. At this time, the correlation information table already contains the correlation about the location area identifier “1234”, namely, the location area identifier of the area covered by base station 1. Therefore, the management device finds the item corresponding to the location area identifier “1234”, and a “bitwise OR” operation is performed for the existing channel code “0x0001” and the new channel code “0x0020”. That is, a bitwise OR operation is performed for the “0000, 0000, 0000, 0001” and “0000, 0000, 0010, 0000”, and “0000, 0000, 0010, 0001”, namely 0x0021, which indicates that there are two possible working channels, is obtained. A correlation success response is returned. The configuration device accesses short-distance radio networks 3 and 4 in the same way, and perform location correlation separately. The short-distance radio networks 3 and 4 locate in the area beyond the coverage of base station 1, and the configuration device send a correlation request command to the management device through the base station in the current area, namely, base station 2. After receiving the correlation request command from the short-distance radio network 3, the management device adds a new correlation to the correlation information table. The new correlation is a correlation between the working channel “0x0400” of the short-distance radio network 3 and the location area identifier “1235” of base station 2, and the corresponding channel code is 0x0400. After receiving the correlation request command from the short-distance radio network 4, the management device performs a bitwise OR operation for the working channel code “0x8000” of network 4 and the channel code “0x0400” currently correlated with the location area identifier “1235”, and the operation result is “0x8400”.

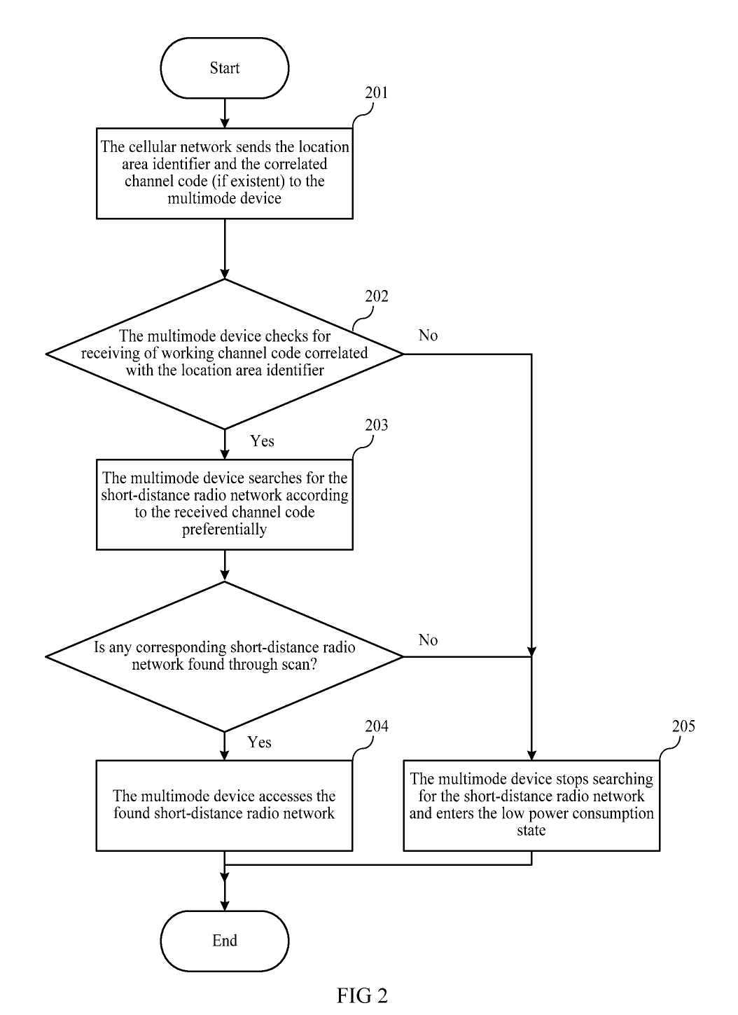

After the short-distance radio network is configured and put into use, the multimode device may search for the short-distance radio network through configured correlation, as shown in FIG. 2. In step 201, the multimode device accesses base station 1, and the cellular network sends the location area identifier “1234” of base station 1 to the multimode device. Moreover, the management device of the cellular network obtains the channel code “0x0021” corresponding to the location area identifier “1234” by searching the correlation information table. The location area identifier is sent with the working channel code “0x0021” correlated with the location area identifier. If no working channel code is correlated with the location area identifier of the area covered by the base station currently accessed by the multimode device, the location area identifier is sent without channel code, or with the all-zero channel code “0x0000”.

In the subsequent step 202, after receiving the location area identifier of the area covered by the accessed base station, the multimode device checks whether the working channel code correlated with the location area identifier is received simultaneously. If the working channel code is received, step 203 is performed; otherwise, step 205 is performed, where the multimode device enters the low power consumption state without searching for the short-distance radio network.

In step 203, the multimode device searches for the short-distance radio network according to the received channel code. The multimode device scans the channels identified by the working channel codes. If the corresponding short-distance radio network is found, step 204 is performed, where the multimode device accesses the found short-distance radio network. If no short-distance radio network is found after all channels identified by the channel codes are scanned, step 205 is performed, where the multimode device stops searching for the short-distance radio network and enters the low power consumption state.

In the preceding step 205, the search for the short-distance radio network may be continued according to the prior art instead of being stopped as described above. That is, the multimode device searches for the short-distance radio network according to the received channel code at first, and subsequently according to the prior art.

In the preceding example, the multimode device may scan channel 1 and channel 6 after receiving the location area identifier “1234” and the corresponding channel code “0x0021”. After finding the short-distance radio network 1 on channel 1, the multimode device may access the radio network 1. When the multimode device moves to the area of the short-distance radio network 2, it is unable to find the access point previously used for communication in the network 1, and the multimode device scans channel 1 and channel 6 again. The multimode device may find the short-distance radio network 2 that provides the same service on channel 6, and access the short-distance radio network 2 without interrupting its service. Therefore, a limited number of correlated channels are scanned when the multimode device searches for the short-distance radio network initially or the multimode device needs to access the short-distance radio network again after moving to another area. If there's a short-distance radio network currently, the multimode device may access the network by scanning a few correlated channels. Thus the network search of the multimode device is quickened, and the power consumption of searching for the network is reduced. If there is no short-distance radio network currently, the multimode device receives no correlated channel code and performs no network search. Thus, unnecessary power consumption is avoided.

In this embodiment, when the multimode device performs location update or handover in the cellular network, it regains the working channel code of the short-distance radio network correlated with the current area, according to the location area identifier of the area. The multimode device may request the management device of the cellular network for the new working channel code, or the cellular network may deliver an after-update location area identifier with the new working channel code correlated with the location area. For example, after the multimode device moves from the coverage of base station 1 to the coverage of base station 2, the cellular network performs location update for the multimode device. During the location update, the cellular network management device searches the location correlation table and finds that the channel code corresponding to the location area identifier “1235” is “0x8400”. Then, the location update message delivered by the cellular network to the multimode device carries the channel code “0x8400”, and the multimode device updates the channel code while updating the location area. Likewise, after the existing short-distance radio network 2 is disconnected, the multimode device may scan channel 11 and channel 16 according to the channel code, and access the short-distance radio network 3 or 4. In the prior art, the scan needs to be performed on 16 channels. By comparison, in the embodiment of the present invention, the scan is performed on the channels correlated with the area where the multimode device is located and the scan time is shortened greatly. For example, if the time required for scanning one channel is 0.5 second, the time required for scanning 16 channels is 8 second. Through the embodiment of the present invention, the required scan time is only 1 second. Besides, the power consumption required for the multimode device to scan the channels is reduced.

The method for a multimode device to search for a radio network in the second embodiment is almost the same as the method in the first embodiment of the present invention. The difference is as follows:

In the first embodiment, the preset correlation is stored in the management device of the cellular network, and the preset correlation is a correlation between the location area identifier of the cellular network and the working channel of the short-distance radio network. In this embodiment, the preset correlation is stored in the management device of the short-distance radio network. The management device may be a node in one of the short-distance radio networks or an independent device, and is connected with each short-distance radio network through a gateway. The preset correlation is a correlation between the location area identifier of the cellular network, the working channel, and the access password of the short-distance radio network.

The location area identifier of each base station in the cellular network and the working channel in each short-distance radio network in the second embodiment are the same as those in the first embodiment, and the network keys of the four short-distance radio networks are K1, K2, K3 and K4 respectively.

At the time of setting up a correlation, the configuration device accesses one by one the short-distance radio networks that need to be correlated, and sends a correlation request command to the cellular network base station in the area where the network is located. The correlation request command carries the radio network parameters, of the short-distance radio network, such as working channel code. If the cellular network confirms permission of correlation, it returns a correlation response carrying a location area identifier to the configuration device. After receiving the correlation response, the configuration device sends a location message registration command to the management device of the short-distance radio network. The command carries the location area identifier of the cellular network, and the working channel code and the network key of the short-distance radio network. The correlation method of the management device of the short-distance radio network is almost the same as that in the first embodiment. The difference is that the corresponding network password in addition to the working channel code is stored. That is, after correlation, the location area identifier “1234” corresponds to the working channel code “0x0021” and network keys “K1” and “K2”. The location area identifier “1235” corresponds to the working channel code “0x8400” and network keys “K3” and “K4”.

When the multimode device accesses any short-distance radio network, the multimode device may request the correlation information of the current area from the management device of the short-distance radio network. If the management device consents, the management device sends the working channel code and the network key correlated with the location area identifier of the current area to the multimode device, and the multimode device stores the correlation information. When the multimode device moves, the multimode device searches for the network according to the correlated working channel code. After a short-distance radio network is found, all possible correlated network keys are sent to the short-distance radio network for authentication.

In this embodiment, when the multimode device performs location update or handover in the cellular network, it regains the working channel code and network key of the short-distance radio network correlated with the current area from the management device of the short-distance radio network, according to the location area identifier of the area. This ensures that the correlated working channel code is updated in time, and the multimode device may search for the network quickly according to the working channel code correlated with the corresponding area, and potential failure of finding any short-distance radio network due to channel code errors may be avoided as well.

Moreover, the multimode device may obtain all the correlation information at a single attempt from the management device of the short-distance radio network when initially accessing the short-distance radio network, and store such information. Afterward, when location update or handover occurs in the cellular network, the locally stored correlation information is directly available for the search to update the working channel code and the network key of the short-distance radio network correlated with the current area. This may help to avoid the consequence as follows: When the multimode device performs location update or handover in the cellular network, the multimode device is unable to update the working channel code or network key of the short-distance radio network correlated with the current area due to disconnection from the short-distance radio network.

The multimode device may request the latest correlation information from the management device of the short-distance radio network automatically at intervals, or is trigged by the user periodically to obtain the latest correlation information. This may help to prevent the correlation information stored in the management device of the short-distance radio network from changing.

The method for a multimode device to search for a radio network in the third embodiment is almost the same as the method in the first or second embodiment of the present invention. The difference is as follows:

In the first or second embodiment, when configuring the short-distance radio network initially, the configuration device correlates the area identifier information of the second network with the radio network parameters of the first network, namely, short-distance radio network, and stores the correlation information in the management device of the first network or the second network. The correlated radio network parameters of the first network are working channel codes. In this embodiment, the multimode device performs the corresponding correlation when accessing each short-distance radio network initially, and stores the correlation information in the multimode device. The correlated radio network parameters are the network identifier and the working channel code of the first network, that is network identifier and working channel code of each short-distance radio network. After correlation, when the multimode device moves, the working channel of the corresponding short-distance radio network may be searched out directly according to the location area identifier of the current area, and don't have to be obtained from other management devices.

When performing location correlation, the multimode device accesses the short-distance radio network to be correlated, and obtains the information about the working channel and network identifier of the short-distance radio network at the same time. Afterward, the multimode device sends a correlation request command to the cellular network base station in the area where the network is located. The correlation request command carries the information about the working channel of the short-distance radio network. If confirming permission of correlation, the cellular network returns a correlation response to the multimode device, where the response carries a location area identifier. After receiving the correlation response, the multimode device correlates the location area identifier with the working channel and the network identifier of the short-distance radio network, and stores the correlation information. The specific correlation method is similar to that in the first or second embodiment, and is not repeated here any further.

In this embodiment, there may be more than one working channel of a short-distance radio network. Each short-distance radio network may have an active working channel and a standby working channel. When performing correlation, the multimode device may perform correlation for both the active working channel and the standby working channel.

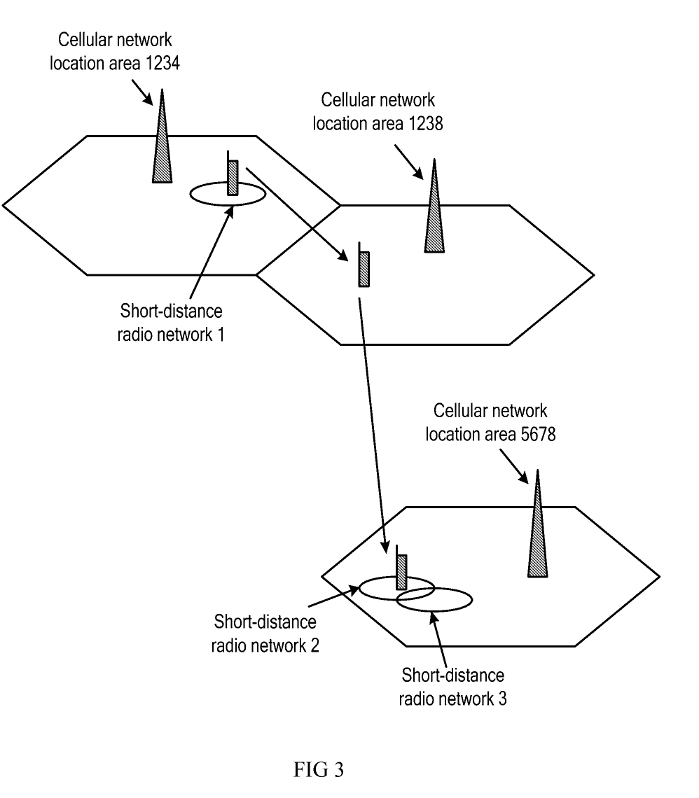

For example, as shown in FIG. 3, the user deploys two short-distance radio networks at home, and deploys one short-distance radio network in the office. A short-distance radio network has 10 optional working channels. The short-distance radio network 1 is deployed in the office, with channel 1 serving as an active channel and channel 6 serving as a standby channel. The short-distance radio network 1 with “0x0001” as the network identifier is located in the cellular network location area “1234”. The short-distance radio networks 2 and 3 are deployed at home, with channels 3 and 7 serving as active channels and channels 8 and 2 as standby channels. The short-distance radio networks 2 with “0x0002” as the network identifier and the short-distance radio networks 3 with “0x0003” as the network identifier are located in the cellular network location area “5678”. No short-distance radio network is deployed by the user in the cellular network location area “1238”.

The user performs location correlation through a multimode device, for example, a multimode mobile station of the user. The information stored in the multimode device after correlation includes: channel code “0x0021” (channel 1 and standby channel 6) and network identifier “0x0001” corresponding to the location area identifier “1234”; channel code “0x00C6” (channels 2, 3, 7, 8) and network identifiers “0x0002” and “0x0003” corresponding to the location area identifier “5678”. No channel code or network identifier is correlated with the location area identifier “1238”.

Upon completion of correlation, the user may use the correlation information to enhance the mobility performance of the multimode device. Supposing that the user stays in the office where the location area identifier is “1234”, and the multimode device searches the stored correlation information automatically to obtain the channel code “0x0021” and network identifier “0x0001” correlated with the current area. Further, the multimode device searches channel 1 and channel 6 for the short-distance radio network 1 with the network identifier “0x0001” consistent with the correlated network identifier. As a result, the multimode device requests to access the short-distance radio network 1 directly.

Subsequently, the user moves to the location area “1238”. The multimode device discovers disconnection from the short-distance radio network 1 and no corresponding network is found in the correlation information stored in the multimode device. Therefore, the multimode device considers there's no network desired by the user, and the short-distance radio access module enters the low power consumption state automatically instead of searching for a new network.

Afterward, the user moves to location area “5678”. The multimode device performs handover, and obtains location area identifier “5678”. Through searching, the multimode device obtains the corresponding channel code “0x00C6” and network identifiers “0x0002” and “0x0003”. The multimode device searches for channels 2, 3, 7 and 8 automatically, and finds the short-distance radio network 2. The short-distance radio network 2 has a network identifier “0x0002”, which is the same as one of the correlated network identifiers. Therefore, the multimode device accesses the short-distance radio network 2. Likewise, if the user moves to short-distance radio network 3, the multimode device may access the short-distance radio network 3 according to the corresponding channel code and network identifier.

The method for a multimode device to search for a radio network in the fourth embodiment is almost the same as the method in the third embodiment of the present invention. The difference is as follows:

In the third embodiment, the working channel of the correlated short-distance radio network is represented by a 2-byte hexadecimal code. In this embodiment, the short-distance radio access mode uses a frequency hopping technology. Therefore, the radio network parameters may be channel information, for example, a frequency hopping sequence number represented by a number. When performing location correlation, the multimode device or configuration device sends a correlation request command and a location message registration command, both carrying a frequency hopping sequence number that represents the corresponding working channel. In the correlating operation, the location area identifier of the cellular network is correlated with the frequency hopping sequence number and optional network identifier of the short-distance radio network.

Likewise, when the multimode device moves, the correlated frequency hopping sequence number is obtained according to the location area identifier of the current area, and a short-distance radio network is searched out according to all the correlated frequency hopping sequence numbers. Through the method under the embodiment of the present invention, the corresponding short-distance radio network may be found by attempting only a limited number of frequency hopping sequences. Thus the time required for the mobile station to access the network is shortened, and the weakness of a long time taken for the mobile station to access the network is avoided in the short-distance radio network based on the frequency hopping technology. Moreover, the correlated network identifiers may be compared to avoid attempt to access other unrelated networks, and power consumption of the device is reduced.

The method for a multimode device to search for a radio network in the fifth embodiment is almost the same as the method in the first embodiment of the present invention. The difference is as follows:

In the first embodiment, the first network is a short-distance radio network, and the multimode device searches for a new network only when the connection with the old short-distance radio network is interrupted in the motion process. In this embodiment, the first network is a Wireless Local Area Network (WLAN), and the multimode device performs network search and handover when the signals of connection with the old WLAN are weak.

In this embodiment, the location area identifier of the cellular network is correlated with the radio network parameters such as a working channel code of the WLAN at first. The correlation mode is the same as that in the first embodiment. The difference is as follows:

In the first embodiment, the working channel code of the short-distance radio network is correlated, and the configuration device accesses all short-distance radio networks one by one to request correlation. In this embodiment, the working channel of the WLAN is correlated, and the configuration device accesses all WLANs one by one to request correlation.

After successful correlation, the multimode device used by the user may access the cellular network and the WLAN at the same time. When the multimode device moves between different WLANs, the multimode device scans the network periodically and measures the strength of the receiving signals. Rather than searching for the network after the connection is interrupted, the multimode device performs handover only if the strength of the signals at the old access point is relatively low and the strength of the signals at the new access point is relatively high.

The method for a multimode device to search for a radio network in the sixth embodiment is almost the same as the method in the first to fifth embodiments of the present invention. The difference is as follows:

In the first to fifth embodiments, the second network is a cellular network, and the preset correlation is a correlation between the location area identifier of the cellular network and the network parameters of the short-distance radio network or WLAN. In this embodiment, the first network is a short-distance radio network, the second network is a WLAN, and the preset correlation is a correlation between the network identifier of the WLAN and the radio network parameters of the short-distance radio network.

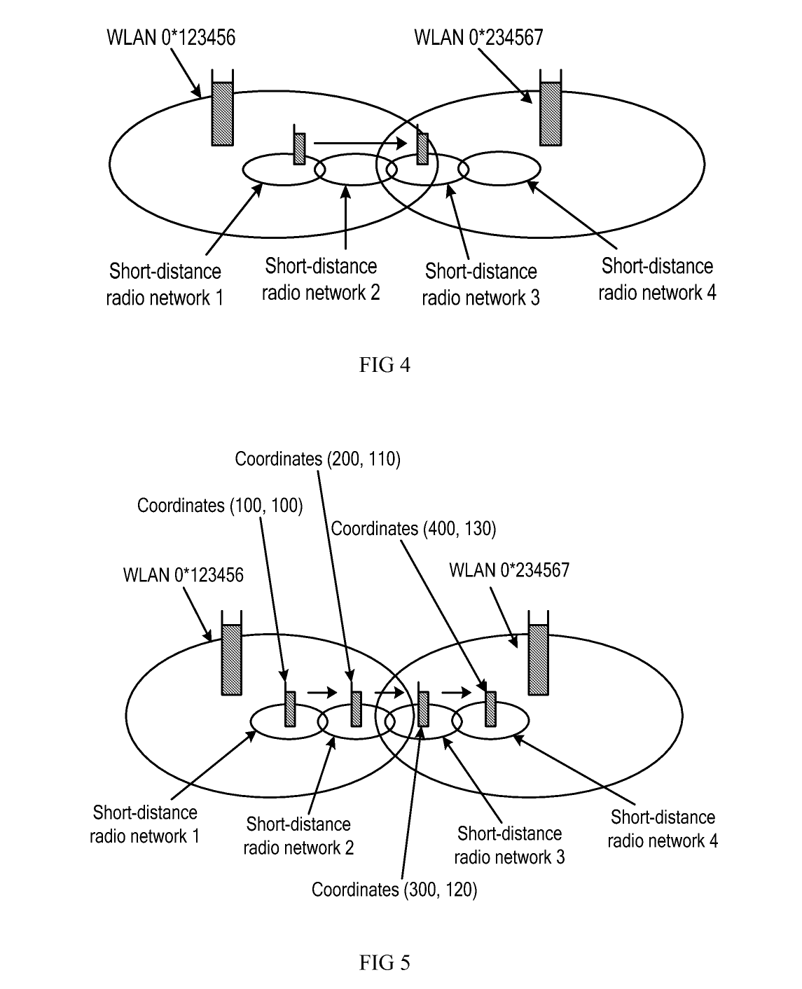

The WLAN network identifier is also known as a Basic Service Set Identifier (BSSID). In the IEEE 802.11, the BSSID is represented by 48 bits. In the following description, different WLANs are identified by a BSSID. As shown in FIG. 4, part of short-distance radio networks 1, 2 and 3 is located in the area of the WLAN 0x123456, and part of short-distance radio network 4 and 3 is located in the area of the WLAN 0x234567. Short-distance radio networks 1, 2, 3 and 4 use channels 1, 3, 5 and 7 respectively. Moreover, there is a management entity for managing two WLANs uniformly in WLAN.

In this embodiment, location correlation is preset. That is, the network identifier of the WLAN is correlated with the channel code of the short-distance radio network. The configuration device or the multimode device itself may send a correlation request command to the management entity of the WLAN. The specific correlation process is similar to the process in any of embodiments 1-5. The specific operation of the management entity of the WLAN is the same as that in embodiments 1-5, and is not repeated here any further. The correlation information may be stored in the management device of the short-distance radio network, the management device of the WLAN, or the multimode device.

After correlation, the network “0x123456” corresponds to the channel code “0x0015” (including channels 1, 3 and 5), and the network “0x234567” corresponds to the channel code “0x0054” (including channels 3, 5 and 7).

When accessing the WLAN “0x123456”, the multimode device may obtain the correlated channel code “0x0015” locally or from a management entity, and store it in the internal memory. When searching for a network, the multimode device searches on the channels 1, 3 and 5 according to the channel code “0x0015”, thus finding the short-distance radio network existent in the current area quickly and reducing the power consumption of network search. If the network search performed according to the channel code fails, the multimode device may be currently not in the area of the short-distance radio network, and the multimode device enters the low power consumption state without performing further network search. When the multimode device performs handover or location update in the WLAN, it regains the channel code correlated with the WLAN network identifier existent after handover or update, with a view to ensuring that the channel code stored in the multimode device corresponds to the current area and to ensuring the accuracy of network search. Generally, the time of handover between WLANs is shorter than the time of handover between many other short-distance radio networks, and the delay of handover between short-distance radio networks is not increased. Compared with the prior art, the delay of handover between short-distance radio networks is slashed.

The method for a multimode device to search for a radio network in the seventh embodiment is almost the same as the method in the sixth embodiment of the present invention. The only difference is as follows:

In sixth embodiment, the identifier information of the WLAN area for location correlation is a network identifier. In this embodiment, the identifier information of the area for location correlation is positioning information represented by circle center coordinates and a radius. Compared with the method for determining a location according to a network identifier, the method based on the positioning technology provides much higher precision. A multimode device may uniquely determine whether the current location has a short-distance radio network and determine the working channel of the short-distance radio network, without scanning all possible working channels in the current area or attempting other network access. Compared with the preceding embodiments, this embodiment provides the minimum delay of network search, and the minimum power consumption.

Specifically, a WLAN may use existing positioning technologies. When a multimode device accesses the network, the multimode device knows its own location information. Therefore, in the process of setting up a location correlation, the radio network parameters of the short-distance radio network are correlated with the coverage area of the WLAN corresponding to the short-distance radio network. Precise location information is rather helpful for handover between short-distance radio networks.

The network deployment in this embodiment is the same as that in the sixth embodiment. As shown in FIG. 5, the configuration device or multimode device accesses the short-distance radio network 1, and sends a correlation request command to the WLAN “0x123456” accessed at the same time. After accepting the request, the WLAN returns a correlation response that carries location information such as coordinates (100, 100) and a radius “50”. The coordinates and radius serve as correlation information. The configuration device or multimode device sends the information to the management entity of the short-distance radio network. The channel code “0x0001” corresponds to the area defined by a circle, with the circle center being (100, 100) and the radius being 50. The configuration device or multimode device initiates similar processes in the remaining short-distance radio networks one by one to set up a correlation between short-distance radio network 2 and short-distance radio network 4. The information about the set correlation is:

an area defined by a circle, corresponding to the channel code “0x0004” (short-distance radio network 2), where the circle center is (200, 110) and the radius is 50;

an area defined by a circle, corresponding to the channel code “0x0010” (short-distance radio network 3), where the circle center is (300, 120) and the radius is 50; and

an area defined by a circle, corresponding to the channel code “0x0040” (short-distance radio network 4), where the circle center is (400, 130) and the radius is 50.

After the correlation is set successfully, when the multimode device may store all correlation information locally and then access the WLAN. The WLAN delivers the positioning information of the multimode device periodically, or the multimode device requests the positioning information actively. According to the obtained positioning information, the multimode device judges whether any correlated working channel of the short-distance radio network exists in the current location. If the working channel exists, the multimode device scans the channel, and accesses the corresponding short-distance radio network. For example, when the multimode device moves to coordinates (200, 120), the multimode device may scan channel 3 to search for a network if the positioning information is updated and the corresponding correlated channel code is found to be 0x0004. After the multimode device moves to another area, new positioning information is obtained. The multimode device may obtain the corresponding channel code synchronously according to the new positioning information, thus performing handover quickly without consuming too much time for network search.

In this embodiment, the second network is not necessarily a WLAN. This embodiment is accomplishable if the second network is any network with a positioning function. The effect of reducing the delay of network search may be accomplished in almost the same process no matter whether the second network is a cellular network with the positioning function, for example, a cellular network with GPS functions or other short-distance radio networks with the positioning function.

The method for a multimode device to search for a radio network in the eighth embodiment is almost the same as the method in the preceding seven embodiments of the present invention. The difference is as follows:

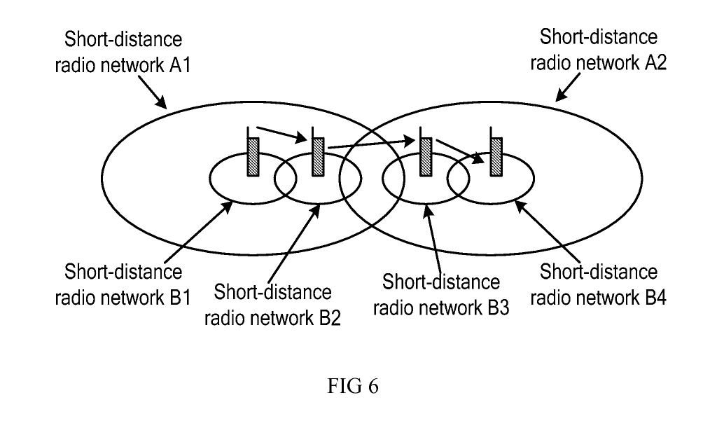

In the preceding seven embodiments, the coverage of each area or each subnet in the second network is wider than the coverage of the first network; that is, an area in the second network may be correlated with multiple first networks. In this embodiment, the coverage of each area or each subnet in the second network is smaller than the coverage of the first network; that is, a first network is covered by multiple areas or subnets in the second network. As shown in FIG. 6, both the first network and the second network are short-distance radio networks, namely, short-distance radio network A and short-distance radio network B.

In this embodiment, a correlation is set up with the short-distance radio network B so that the multimode device can search all short-distance radio networks of the short-distance radio network A quickly to shorten delay of network search and quicken the network handover, where the short-distance radio networks may be regarded as subnets of the short-distance radio network A.

As shown in FIG. 6, the short-distance radio network A1 uses channel 1, and the short-distance radio network A2 uses channel 6. There are eight available channels in total.

The user may perform location correlation through a multimode device, and store the correlation information in the multimode device. After correlating, the short-distance radio network B1 corresponds to the channel code “0x01” of the short-distance radio network A1, where A1 and B1 are network identifiers; the short-distance radio network B2 corresponds to the channel code “0x21” (channel 1 and channel 6) and network identifiers A1 and A2; the short-distance radio network B3 corresponds to the channel code “0x21” (channel 1 and channel 6) and network identifiers A1 and A2; and B4 corresponds to the channel code “0x20” and network identifier “A2”.

After the multimode device accesses any network in the short-distance radio network B, the multimode device may search the correlation information and judge whether there's any subnet of the short-distance radio network A in the current location. If any correlation exists, the multimode device searches short-distance radio network A according to the correlated channel code. For example, after accessing the short-distance radio network B1, the multimode device obtains the channel code “0x01” correlated with the short-distance radio network B1, and scans channel 1 according to the channel code, thus being able to access the short-distance radio network A1 quickly. After moving to other subnets, such as network B2, of the short-distance radio network B, the multimode device updates the correlated channel code automatically. When network search is required, for example, when the current connection is interrupted, the multimode device scans channels 1-6 one by one according to the updated channel code “0x21”, and accesses the short-distance radio network A1 or A2. If the multimode device is unable to obtain any correlation information after moving to an area covered by no subnet of the short-distance radio network B, the network search may be performed on all channels according to the prior art. In this way, the multimode device is also able to uniquely determine the channel code of the short-distance radio network A corresponding to the current area, and access the corresponding network by scanning only one channel, thus minimizing the delay and power consumption. However, in this method, the coverage of the second network is too small to cover all subnets of the first network. Consequently, correlation is impossible in certain areas, and the multimode device still needs to be scan all available channels one by one according to the prior art.

In the preceding embodiments, the first network may be a WPAN, Wireless Metropolitan Area Network (WMAN), or WLAN. For example, the preceding short-distance radio network is equivalent to a WPAN. The second network may be a WPAN, Wireless Wide Area Network (WWAN), WPAN, or WLAN. For example, the preceding cellular network is a WWAN.

Described above is a method for a multimode device to search for a radio network in the embodiments of the present invention. A system for a multimode device to search for a radio network and a multimode device are also provided herein.

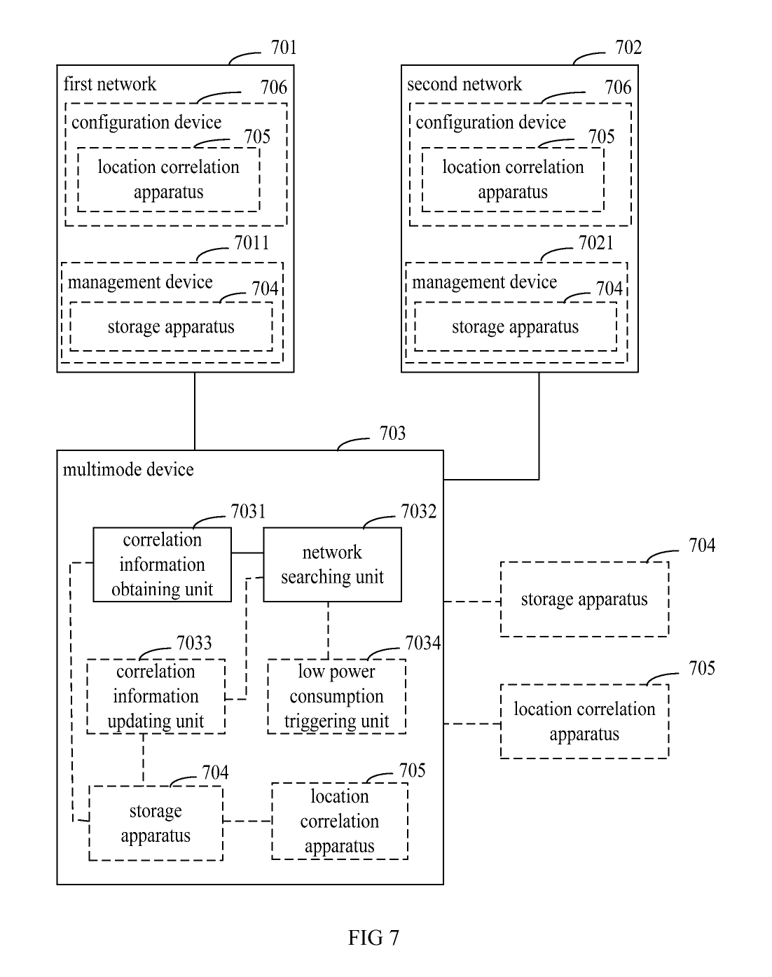

As shown in FIG. 7, the system for a multimode device to search for a radio network in the first embodiment of the present invention includes: a first network 701 corresponding to a mode, a second network 702 corresponding to a different mode, a multimode device 703 supporting at least the two modes, and a storage apparatus 704.

The storage apparatus 704 is configured to store information about correlation between the identifier information of each area in the second network 702 and the radio network parameters of the first network 701 in each area. The storage apparatus 704 may be set in any of these devices: management device 7011 of the first network 701, management device 7021 of the second network 702, and multimode device 703.

The multimode device 703 includes:

a correlation information obtaining unit 7031, configured to obtain the radio network parameters of the first network 701 correlated with a current area in the second network 702 from the foregoing storage apparatus 704 according to the identifier information of the area when the multimode device 703 moves; and

a network searching unit 7032, configured to search the first network 701 according to the obtained radio network parameters.

The foregoing multimode device 703 may further include a correlation information updating unit 7033, configured to regain, from the foregoing storage apparatus 704, the radio network parameters of the first network 701 correlated with an area existent after location update or handover according to the identifier information of the area when the multimode device 703 performs location update or handover in the second network 702. Therefore, the multimode device 703 may perform network search according to the radio network parameters corresponding to the area visited by the multimode device 703 after moving, thus improving the accuracy of network search. The correlation information updating unit 7033 and the foregoing correlation information obtaining unit 7031 may be located in a physical unit or logical unit.

The multimode device 703 further includes a low power consumption triggering unit 7034, configured to instruct the network searching unit 7032 to stop searching after determining that no radio network parameter of the first network 701 is correlated with the area in the second network 702 where the multimode device 703 is currently located, with a view to triggering the multimode device 703 to enter the low power consumption state. In this way, the multimode device 703 is prevented from performing unnecessary network search and consuming device resources futilely.

The system further includes an apparatus 705 for initiating location correlation beforehand. The location correlation apparatus 705 may be set in a configuration device 706 or the multimode device 703 mentioned above. The configuration device 706 may be located in the first network 701 or the second network 702. The location correlation apparatus 705 initiates location correlation in one of the following modes.

The location correlation apparatus 705 set in the multimode device 703 obtains the identifier information of the current area in the second network 702 and the radio network parameters of the first network 701 in the area, with a view to initiating and setting up a correlation, and stores the correlation information into the foregoing storage apparatus 704.

Optionally, the location correlation apparatus 705 set in the configuration device 706 or multimode device 703 obtains the identifier information of the current area in the second network 702, sends the identifier information to the first network 701, triggers the management device 7011 of the first network 701 to correlate the identifier information with the radio network parameters of the first network 701 in the area, and stores the correlation information into the foregoing storage apparatus 704.

Optionally, the location correlation apparatus 705 set in the configuration device 706 or multimode device 703 obtains the radio network parameters of the first network 701 where the location correlation apparatus 705 is currently located, sends the radio network parameters to the second network 702, triggers the management device 7021 of the second network 702 to correlate the radio network parameters with the identifier information of the current area in the second network 702, and stores the correlation information into the foregoing storage apparatus 704.

In this embodiment, the identifier information of the area in the second network 702 is: subnet identifier of the area in the second network 702, such as a network identifier of each short-distance radio network or WLAN deployed by the same user or operator, or location area identifier of the area in the second network 702, such as a location area identifier corresponding to a coverage area of different base stations in a cellular network, or positioning information of the area in the second network 702, such as coordinates and a coverage radius in a WLAN.

The radio network parameters of the first network 701 are: information about the working channel of the first network 701, such as a channel code or frequency hopping sequence number, or a subnet identifier of the first network 701, such as a network identifier of each short-distance radio network or WLAN deployed by a user or operator, or a network key of the first network 701, such as a network key of each short-distance radio network deployed by a user or operator, or any combination thereof.

The first network 701 may be a WPAN, WMAN, or WLAN. The second network 702 may be a WPAN, WWAN, WMAN, or WLAN. The coverage of each subnet or area in the first network 701 may be greater or smaller than that in the second network 702.

Because a correlation is preset and the corresponding area in the second network 702 is correlated with a limited number of parameters of the first network 701, the scope of network search is reduced, the handover delay is shortened, the search of unrelated parameters is avoided in the network, and the power consumption of network search is reduced.

The specific contents of the radio network parameters of the first network 701, the specific contents of the identifier information of the area in the second network 702, and the scope of the first network 701 and the second network 702 described above are not only applicable to this embodiment, but also applicable to other embodiments of the present invention.

In summary, because the network in a different area corresponds to different network parameters, the delay is long and more power is consumed if the multimedia device performs network search for all the possible network parameters every time when performing network handover. Therefore, in the embodiments of the present invention, the multimode device uses the second network as an area reference. A correlation is preset between each area in the second network and the radio network parameters of the first network in the area. Therefore, the multimode device search the first network according to the radio network parameters of the first network correlated with the current area in the second network when it moves. Because the corresponding area in the second network is correlated with a limited number of parameters of the first network, the scope of network search is narrowed, the handover delay is shortened, the search of unrelated parameters is avoided in the network, and the power consumption of network search is reduced.

The correlation information may be stored in the management device of the first network, or the management device of the second network, or stored in the multimode device directly. The first two types of storage methods make the information highly sharable, and eliminate the possibility of repeated storage of information. The last method enables the multimode device to obtain the parameters of the first network corresponding to the area where the multimode device is located, and quickens network search.

When performing location update or handover in the second network, the multimode device regains the radio network parameters of the first network correlated with the area existent after location update or handover according to the identifier information of the area. In this way, it is ensured that the radio network parameters are updated synchronously and the multimode device searches for the network quickly according to the correlated radio network parameters.

If no radio network parameter of the first network is correlated with the area in the second network where the multimode device is currently located, the multimode device stops searching for the network and enters the low power consumption state, thus avoiding futile operations of network search and reducing power consumption of network search of the multimode device.

One embodiment includes a computer program product which is a machine readable medium (media) having instructions stored thereon/in which may be used to program one or more computing devices to perform any of the features presented herein. The machine readable medium may include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and applications.

Although the invention has been described through some exemplary embodiments, the invention is not limited to such embodiments. It is apparent that those skilled in the art can make various modifications and variations to the invention without departing from the scope of the invention. The invention is intended to cover the modifications and variations provided that they fall in the scope of protection defined by the following claims or their equivalents.

What is claimed is:

1. A method for a multimode device to search for a radio network, comprising:
obtaining, by the multimode device, radio network parameters of a first network correlated with a current area according to identifier information of the current area and correlation information, wherein the correlation information presents a correlation between identifier information of an area in a second network and radio network parameters of the first network in the area; and
searching the first network according to the radio network parameters.

2. The method of claim 1, wherein the correlation between the identifier information of the area in the second network and the radio network parameters of the first network in the area is preset by a management device of the first network, or a management device of the second network, or the multimode device.

3. The method of claim 2, wherein the process that the correlation between the identifier information of the area in the second network and the radio network parameters of the first network in the area is preset comprises:
obtaining, by the multimode device, the identifier information of the current area in the second network and the radio network parameters of the first network in the area, and initiating and setting up the correlation; or
obtaining, by a configuration device or the multimode device, the identifier information of the current area in the second network, sending the identifier information to the first network, and triggering the management device of the first network to correlate the identifier information with the radio network parameters of the first network in the area; or
obtaining, by the configuration device or the multimode device, the radio network parameters of the first network in which the device is currently located, sending the radio network parameters to the second network, and triggering the management device of the second network to correlate the radio network parameters with the identifier information of the current area in the second network.

4. The method of claim 1, further comprising:
regaining, by the multimode device, the radio network parameters of the first network correlated with the area existent after location update or handover according to the identifier information of the area and the correlation information, when performing the location update or handover in the second network.

5. The method of claim 1, further comprising:
stops searching, by the multimode device, the first network and entering a low power consumption state if the correlation information contains no radio network parameters of the first network correlated with the area in the second network in which the multimode device is currently located.

6. The method of claim 1, wherein the identifier information of the area in the second network is:
a subnet identifier of the area in the second network, or a location area identifier of the area in the second network, or positioning information of the area in the second network.

7. The method of claim 1, wherein the radio network parameters of the first network are:
information about working channels of the first network, or a subnet identifier of the first network, or a network key of the first network, or any combination thereof.

8. The method of claim 7, wherein the information about the working channels comprises: a working channel code or a frequency hopping sequence number.

9. The method of claim 1, wherein:
the first network is: a Wireless Personal Area Network, WPAN; or a Wireless Metropolitan Area Network, WMAN; or a Wireless Local Area Network, WLAN; and
the second network is: a WPAN; or a Wireless Wide Area Network, WWAN; or a WMAN; or a WLAN.

10. A telecommunication system, comprising: a first network corresponding to a mode, a second network corresponding to a different mode, a multimode device supporting at least the two modes; the system further comprising:
a storage apparatus, configured to store information about correlation between identifier information of an area in the second network and radio network parameters of the first network in the area; and
a multimode device, configured to: obtain the radio network parameters of the first network correlated with a current area according to the identifier information of the current area and the correlation information stored, and search the first network according to the radio network parameters.

11. The system of claim 10, wherein the storage apparatus is arranged in any one of these devices: a management device of the first network, a management device of the second network, and the multimode device.

12. The system of claim 10, further comprising: a location correlation apparatus configured to:
obtain the identifier information of the current area in the second network and the radio network parameters of the first network in the area, with a view to initiating and setting up a correlation, and store the correlation information into the storage apparatus; or
obtain the identifier information of the current area in the second network, send the identifier information to the first network, trigger the management device of the first network to correlate the identifier information with the radio network parameters of the first network in the area, and store the correlation information into the storage apparatus; or
obtain the radio network parameters of the first network in which the location correlation apparatus is currently located, send the radio network parameters to the second network, and trigger the management device of the second network to correlate the radio network parameters with the identifier information of the current area in the second network, and store the correlation information into the storage apparatus.

13. The system of claim 12, wherein the location correlation apparatus is set in the multimode device or a configuration device.

14. The system of claim 10, wherein:
the identifier information of the area in the second network is: a subnet identifier of the area in the second network, or a location area identifier of the area in the second network, or positioning information of the area in the second network; and
the radio network parameters of the first network are: working channels of the first network, or a subnet identifier of the first network, or a network key of the first network, or any combination thereof.

15. The system of claim 10, wherein:
the first network is: a Wireless Personal Area Network, WPAN; or a Wireless Metropolitan Area Network, WMAN; or a Wireless Local Area Network, WLAN; and
the second network is: a WPAN; or a Wireless Wide Area Network, WWAN; or a WMAN; or a WLAN.

16. A multimode device, comprising:
a correlation information obtaining unit, configured to obtain radio network parameters of a first network correlated with a current area in a second network according to identifier information of the area; and
a network searching unit, configured to search the first network according to the radio network parameters obtained.

17. The multimode device of claim 16, further comprising:
a storage apparatus, configured to store information about a correlation between the identifier information of the area in the second network and the radio network parameters of the first network in the area.

18. The multimode device of claim 16, further comprising:
a correlation information updating unit, configured to regain the radio network parameters of the first network correlated with the area existent after location update or handover according to the identifier information of the area when the multimode device performs the location update or handover in the second network; and
a network searching unit, configured to perform network search according to the regained radio network parameters regained.

19. The multimode device of claim 16, further comprising:
a low power consumption triggering unit, configured to instruct the network searching unit to stop searching after determining that no radio network parameter of the first network is correlated with the area in the second network in which the multimode device is currently located; and
the network searching unit, configured to stop the network search as instructed.

20. The multimode device of claim 16, further comprising: a location correlation apparatus configured to:
obtain the identifier information of the current area in the second network and the radio network parameters of the first network in the area, and initiate and set up the correlation; or
obtain the identifier information of the current area in the second network, send the identifier information to the first network, and trigger the management device of the first network to correlate the identifier information with the radio network parameters of the first network in the area; or
obtain the radio network parameters of the first network in which the location correlation apparatus is currently located, send the radio network parameters to the second network, and trigger the management device of the second network to correlate the radio network parameters with the identifier information of the current area in the second network.
